(19) United States
(12) Patent Application Publication
(10) Pub. No.: US 2017/0321618 A1
(43) Pub. Date: Nov. 9, 2017

(54) METHOD FOR DETERMINIG THE LOADING STATUS OF A FILTER

(71) Applicant: CONTINENTAL AUTOMOTIVE GMBH, Hannover (DE)

(72) Inventor: Heiko Jausel, Rosbach (DE)

(73) Assignee: CONTINENTAL AUTOMOTIVE GMBH, Hannover (DE)

(21) Appl. No.: 15/658,997

(22) Filed: Jul. 25, 2017

Related U.S. Application Data
(63) Continuation of application No. PCT/EP2016/050923, filed on Jan. 18, 2016.

(30) Foreign Application Priority Data
Jan. 26, 2015 (DE) 10 2015 201 295.6

(51) Int. Cl. F02D 41/22; G01N 15/08; F02M 37/22; F02D 41/30

(52) U.S. Cl. CPC F02D 41/22; F02M 37/22; F02D 41/3082; G01N 15/0806; F02D 2041/224; F02D 2250/31; G01N 2015/084

(57) ABSTRACT

A method for determining the load status of a filter mounted in a fuel supply system, comprising a fuel supply pump and a control unit for controlling the fuel supply pump, the time curve of the rotational speed of the fuel supply pump being detected over a predetermined period of time, and at least one value of the time curve of the rotational speed and its associated detection time being compared with a comparative value stored in a control unit

### CROSS-REFERENCE TO RELATED APPLICATIONS

This application claims the benefit of PCT Application PCT/EP2016/050923, filed Jan. 18, 2016, which claims priority to German Application DE 10 2015 201 295.6 filed Jan. 26, 2015. The disclosures of the above applications are incorporated herein by reference.

### FIELD OF THE INVENTION

The invention relates to a method for determining the loading state of a filter situated in a fuel supply system, comprising a fuel supply pump and a control unit for controlling the fuel supply pump.

### BACKGROUND OF THE INVENTION

The fuel used for operating internal combustion engines is naturally contaminated by a multiplicity of disturbing particles. The disturbing particles may negatively influence the combustion in the combustion chamber of the internal combustion engine and thereby worsen the efficiency or contribute to a worsening of the exhaust gas emissions due to dirty combustion. Filters are utilized in order to prevent disturbing particles from entering the combustion chambers and, in addition, to counteract a blockage of the fuel lines. These filters retain disturbing particles of different sizes depending on their design.

A filter has a maximum loading capacity for disturbing particles that depends on the design. In order to ensure a sufficient cleaning effect by the filter, this maximum loading capacity is advantageously not exceeded. The flow of fuel is reduced by a filter that is highly loaded, and the loss of pressure in the fuel supply system caused by the filter increases.

Filters are known in the prior art that are designed, with respect to their maximum loading capacity, according to the regularly anticipated loading during the entire service life of a motor vehicle or a fuel supply system.

A disadvantage of the devices in the prior art is that the filters are regularly oversized in relation to their actual loading with disturbing particles over the service life of the filter and, therefore, the potential to save costs is not taken full advantage of. In addition, there is lack of clarity regarding the actual loading of the filter during operation, and an optimal maintenance or a timely replacement at the maximum operating life of the filter is therefore not possible.

In addition, methods that permit detection of the loading state are known in the prior art. Depending on the values determined for the loading state, a message prompting maintenance or replacement may be output.

DE 38 35 672 A1 discloses a method which accesses values measured by pressure sensors located both upstream and downstream from the filter. By comparing the pressure values with one another, a pressure difference is calculated, which enables an assessment of the loading state of the filter to be carried out.

DE 199 35 237 B4 discloses a method for determining the loading state of a fuel filter located downstream from a supply pump, wherein a pressure sensor is located downstream from the fuel filter. Within the scope of the method, the control deviation between a setpoint pressure value predefined by a control unit and an actual pressure value measured by the sensor is detected, wherein the control deviation is used as a measure of the loading of the fuel filter.

The disadvantage of these methods known from the prior art is that at least one pressure sensor must be provided in the fuel supply system, whereby additional costs are generated and the susceptibility of the system to errors is increased.

### SUMMARY OF THE INVENTION

The problem addressed by the present invention is therefore that of creating a method for determining the loading state of a filter, which makes it possible to detect the loading state in a simple way without the use of additional sensors.

The problem with respect to the method is solved by a method having the features of claim 1.

One exemplary embodiment of the invention relates to a method for determining the loading state of a filter situated in a fuel supply system, comprising a fuel supply pump and a control unit for controlling the fuel supply pump, wherein the temporal progression of the rotational speed of the fuel supply pump is detected over a predefined period of time, and wherein at least one value of the temporal progression of the rotational speed and its associated detection time are compared with a comparative value stored in a control unit.

The fuel supply system may be, for example, the fuel supply system in a motor vehicle comprising an internal combustion engine. Alternatively, the method may also be applied on a fuel supply system in a stationary application. The loading state of a filter describes the extent of contamination of the filter. The greater the contamination is, the lower the delivery quantity is that is delivered through the filter given a constant pump capacity. In addition, the pressure drop caused by the filter increases as the contamination increases.

The function for detecting the progression of the rotational speed of the fuel supply pump is depicted in one of the available control units which also take over the task, for example, of controlling the fuel supply pump.

The rotational speed is detected over a defined period of time. The period of time is, for example, a predefined period of time or may be determined by the start and the end of a certain operating mode of the fuel supply pump. On the basis of the recorded progression of the rotational speed over time, it is determined, for example, how much time has passed since a starting time, i.e., the time “zero”, until a defined rotational speed is present at the fuel supply pump.

The comparative values stored in the control unit is determined empirically or by the use of simulation methods. The comparative values are present in the form of one or multiple characteristic curves or as an entire characteristic map which covers a plurality of different boundary conditions for the operation of the fuel supply pump. In one alternative embodiment, the comparative values may also be stored in the form of a table.

Advantageously, at least characteristic curves for the operation of an identical fuel supply pump comprising a new, non-loaded filter are stored, as well as a characteristic curve for the operation of a fuel supply pump comprising a filter which is loaded up to a critical, predefinable limit. This critical limit may define a point in time, for example, at which a replacement of the filter, or a cleaning measure, becomes necessary.

The detection time describes a point in time that is assigned to a certain rotational speed value, wherein the detection time is determined by the time that has passed since a predefined start point, ideally the time 3.

It is advantageous if the detection time at which a predefined rotational speed is reached is compared with a temporal comparative value assigned to this predefined rotational speed, wherein the loading state of the filter is derived from the time offset.

A comparative value stored in the control unit is used for a value selected from the temporal progression of the rotational speed in order to detect a deviation of the actually detected value from the stored comparative values. In one advantageous embodiment, the entire recorded temporal progression is compared with the stored comparative values.

Provided the control of the fuel supply pump remains constant, as the pressure in the fuel or in the fuel supply system increases, so does the time that passes from a defined starting state until the attainment of a predefined setpoint rotational speed of the fuel supply pump that is higher than the rotational speed in the starting state. The prevailing pressure may therefore be inferred on the basis of the determined time offset between the detected temporal progression of the rotational speed and the stored comparative values, whereby the loading state of the filter may also be inferred. A longer period of time until the setpoint rotational speed is reached is therefore an indication of an increasing loading of the filter.

In addition, the detection time is defined by a prefinable current intensity.

It is advantageous to utilize a current intensity as a characteristic quantity for detecting the rotational speed. Fuel supply pumps are controlled in an easy way by controlling the flowing current. Depending on the fuel supply pump, a constant rotational speed sets in for a certain pressure in the fuel supply system in the case of a constant current supply. By specifying a defined current intensity, it may therefore be expected, under otherwise constant conditions, that a rotational speed specific for the fuel supply pump will be reached in a certain time. If the expected rotational speed is reached earlier or later, this is an indication of a change in the fuel supply system. Under otherwise unchanged operating conditions, a longer time period until the setpoint rotational speed is reached is an indication of an increased pressure in the fuel supply system, which itself is an indication of an increased loading state of the filter.

In addition, it is advantageous if the detected temporal progressions are stored in the control unit and remain available there for a defined period of time, in order to allow for comparisons with further temporal progressions and to derive therefrom a trend with respect to the loading of the filter.

It is also advantageous if the predefined time period over which the temporal progression of the rotational speed is detected corresponds to a run-up of the fuel supply pump from a standstill.

A run-up is advantageous, since a clearly defined zero point is known by way of the beginning of the energization of the fuel supply pump, from which zero point the rotational speed is increased as a result of the current flowing to the fuel supply pump. This procedure is also known as a step response strategy, since a sudden change in current intensity is applied to the fuel supply pump.

Alternatively, the fuel supply pump may also be acted upon even during operation and with a sudden change in current intensity. It is essential that the operating mode selected during the detection of the rotational speed curve was also used as the basis for the stored comparative values, in order to ensure a sufficiently precise comparability.

One exemplary embodiment is characterized in that the comparison between the detected temporal progression of the rotational speed and the stored comparative values takes place continuously.

A continuous comparison is advantageous for being able to make a determination about the loading state of the filter at any time. In deviation from a run-up from a standstill, other operating modes may also be utilized. In order to obtain a reliable finding, it is only necessary to know the starting level in order to ensure that the detected values are comparable. The starting rotational speed and the starting current intensity applied to the fuel supply pump are known. Proceeding therefrom, an arbitrary sudden increase in current intensity is applied to the fuel supply pump and the temporal progression of the rotational speed is detected.

The detection of the temporal progression may take place in a clocked manner at certain predefined points in time. Alternatively, the method may also be initiated in a randomized manner on the basis of a random distribution. The method may also be initiated manually within the scope of maintenance work. Routines for this purpose is stored in the memory of the control unit, which takes over the control of the fuel supply pump.

It is likewise conceivable that the entire temporal progression of the rotational speed is not detected, but rather only individual rotational speeds and the time that has passed since an established reference time, at certain predefined points in time. In this case, for example, the rotational speed of the fuel supply pump is utilized as the trigger for a detection, or a temporal timing of the detections are implemented. The attainment of a predefined current level may also be utilized as a trigger.

The comparative values are determined depending on the temperature of the fuel and/or depending on the fuel quality.

This is advantageous in order to obtain a more precise finding with respect to the loading of the filter. The temperature influences the viscosity of the fuel, whereby the fuel delivery is made easier or more difficult. The necessary delivery pressure is also influenced thereby, which may result in an inaccuracy with respect to the prediction of the filter loading.

The fuel quality is also advantageously taken into account in the comparative values in order to sufficiently precisely account for the different flow properties of different fuels.

In addition, it is advantageous if a calculation of the pressure prevailing in the fuel delivery system also takes place, wherein the fuel supply pump is operated with a constant current intensity at a reference point, whereby a constant rotational speed of the fuel supply pump that is dependent on the pressure prevailing in the fuel delivery system sets in.

The pressure prevailing in the fuel delivery system counteracts the delivery work of the fuel supply pump. Therefore, a different rotational speed sets in at the known fuel supply pump under different pressure ratios in the presence of a given current intensity. A rotational speed that sets in is determined from tests and simulations for each specific fuel supply pump for different pressure ratios.

The current required to reach a defined rotational speed of the fuel supply pump increases as the pressure in the fuel to be delivered increases, and the current decreases with the pressure prevailing in the fuel or the fuel supply system. Therefore, when the rotational speed is known, the pressure prevailing in the fuel or in the fuel supply system is inferred on the basis of the current flowing to the fuel supply pump. By comparing the actually detected values with the stored comparative values, a deviation from the boundary conditions on which the comparative values are based may achieved.

In addition, it is advantageous if the rotational speed of the fuel supply pump that sets in is compared with a comparative rotational speed stored in a control unit, wherein the pressure in the fuel supply system is derived from the rotational speed difference.

The particular pressure is inferred from the above-described correlation between current intensity and rotational speed at a given pressure by energizing the fuel supply pump in a targeted manner, and by way of the rotational speed that sets in. By way of the comparison of the rotational speed that actually sets in for a defined current intensity with the stored comparative value, in particular, particularly precise findings are reached with respect to the pressure prevailing in the fuel supply system.

It is also advantageous if the approach toward a reference point takes place only at a point in time at which the minimum quantity of fuel required at the reference point is greater than the maximum fuel quantity that is presently demanded.

This is necessary in order to ensure a sufficient supply of fuel to the internal combustion engine at all times. An oversupply of fuel is always preferred over an undersupply. If the approach toward a reference point takes place during normal driving operation, in particular, this is particularly important in order to not negatively influence the performance of the motor vehicle. Advantageously, the additional method step is carried out during maintenance of the motor vehicle, when the vehicle is idling, for example, and the required quantity of fuel is low and an adverse effect on the driver is ruled out.

In addition, it is advantageous if at least one limit value is stored in the control unit, wherein a message which is output on a display system is generated if this limit value is exceeded.

A critical pressure, for example, is stored as the limit value. The critical pressure is selected in such a way, in this case, that it corresponds to a loading state of the filter that makes it necessary to perform either a cleaning measure or a replacement measure soon. The limit values may also be stored in the form of a table, as a characteristic curve, or as a characteristic map.

In alternative embodiments, other characteristic values may also be stored as the limit value. For example, the time offset until a certain rotational speed is reached, which is determined from the method according to the invention, may also be used as the limit value.

The exceeding of the limit value may trigger a message which is stored in the control unit. This message is read out, for example, within the scope of regular maintenance, in order to obtain an indication of a high loading state and to initiate a replacement. Alternatively, a message may also be generated, which is output to the driver as visual and/or acoustic feedback.

It is also advantageous if the control unit is formed by the engine control unit. This is advantageous, if the control of the fuel supply pump without a dedicated control unit also takes place directly by the engine control. Alternatively, a separate control unit may also be provided for the fuel supply system. The control unit must be suitable, at least, for detecting and/or determining and/or influencing the rotational speed of the fuel supply pump and the current flowing to the fuel supply pump. The control unit must comprise a memory unit for storing the comparative values. This memory unit is also advantageously suitable for the temporary or long-term storage of detected values.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Advantageous refinements of the present invention are described in the dependent claims and in the description of the Figures that follows. The present invention will become more fully understood from the detailed description and the accompanying drawings, wherein:

FIG. 1 is a diagram showing the temporal progression of the rotational speed of a fuel supply pump, with the continuous time on the X-axis and a rotational speed of a fuel supply pump on the Y-axis;

FIG. 2 is a schematic representation of the current uptake of a fuel supply pump with respect to the rotational speed, wherein the curves for different pressures in the fuel supply system are represented;

FIG. 3 is a schematic representation of the prevailing pressure in the fuel supply system with respect to the rotational speed of the fuel supply pump, wherein the curves for different current intensities are represented; and

FIG. 4 is a flow chart for illustrating the method according to the invention.

### DETAILED DESCRIPTION OF THE PREFERRED EMBODIMENTS

The following description of the preferred embodiment(s) is merely exemplary in nature and is in no way intended to limit the invention, its application, or uses.

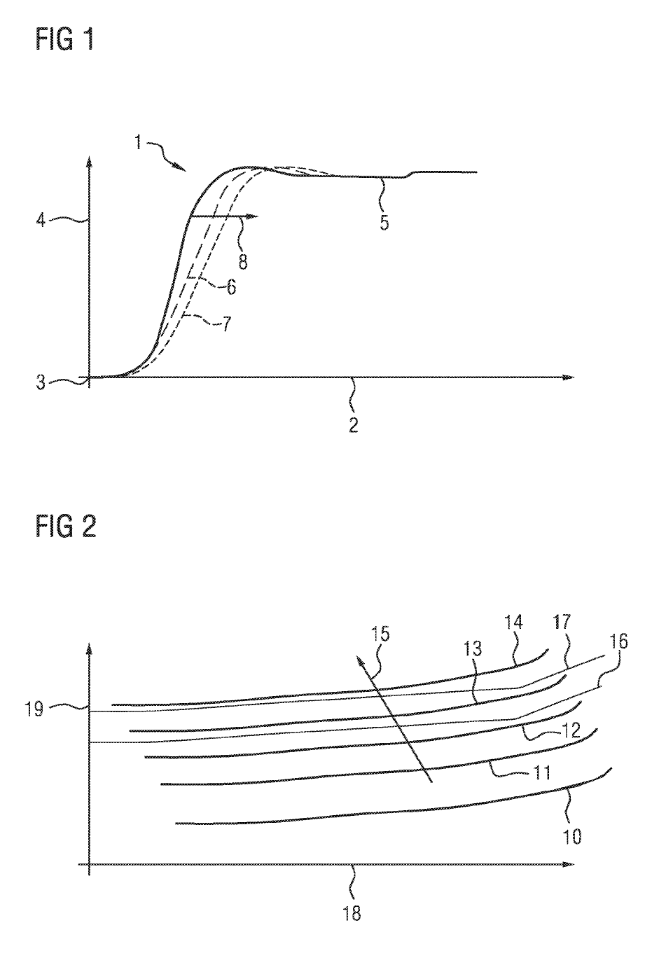

FIG. 1 shows a diagram 1 in which the temporal progression of the rotational speed of a fuel supply pump is represented. The time is continuously plotted on the X-axis 2, proceeding from the zero point 3. The rotational speed is plotted on the Y-axis 4, increasing from the zero point 3.

The curve 5 represents one possible progression of the rotational speed of the fuel supply pump in an operating situation. In the exemplary embodiment in FIG. 1, the zero point 3 forms an operating point at which the fuel supply pump is at a standstill. The temporal progression of the rotational speed represented by the curve 5 corresponds to a run-up of the fuel supply pump from a standstill. This run-up is triggered by an energization of the fuel supply pump. Fuel supply pumps are controlled, inter alia, by varying the current intensity.

The temporal progression of the rotational speed 5 shown in FIG. 1 is the reaction of a fuel supply pump to a step function, i.e., the abrupt application of a voltage and, therefore, the flowing of a current. The rotational speed of the fuel supply pump increases in accordance with the design-specific boundary conditions and the environmental conditions of the fuel supply pump, such as, for example, the pressure ratios in the fuel to be delivered, at a level predefined by the applied voltage or the flowing current. Given a constant current intensity, a constant rotational speed will set in, provided the boundary conditions and environmental conditions remain unchanged.

The curve 5 shows a rotational speed progression for an exemplary fuel supply pump in a fuel supply system comprising a new, non-loaded filter. For each fuel supply pump having the boundary conditions and environmental conditions, a characteristic temporal progression of the rotational speed results in response to a defined step function.

By changing the pump type or, by changing the environmental conditions in the fuel supply system, changes result in the temporal progression 5 of the rotational speed. In FIG. 1, the two exemplary rotational speed curves 6 and 7 show a run-up of the fuel supply pump, wherein the rotational speed curves 6 and 7 are each based on changed environmental conditions.

In FIG. 1, it is apparent that, in the case of the rotational speed curves 6 and 7, a given rotational speed is reached at a later point in time than is the case with the rotational speed curve 5. This is caused, for example, by a higher prevailing pressure in the fuel supply system. The pressure in the fuel supply system is influenced, inter alia, by the loading state of the filter. An increased loading state results in an increased pressure in the fuel supply system, which, in turn, contributes to a delayed attainment of the desired rotational speed of the fuel supply pump.

Within the scope of the method according to the invention for determining the loading of the filter, a rotational speed curve 5, which is characteristic of the fuel supply system in the starting state, is compared with the rotational speed curves 6 and 7. The loading state of the filter is inferred from the time difference which is detected for a certain rotational speed level.

The arrow 8 shows the direction in which the rotational speed curves 6, 7 travel due to the increasing loading of the filter or the increasing pressure in the fuel supply system.

FIG. 2 shows a schematic representation of the current uptake of a fuel supply pump with respect to the rotational speed. The curves 10, 11, 12, 13 and 14 show the current uptake for a constant pressure in the fuel supply system in each case. The curve 10 shows the lowest pressure and the curve 14 shows the highest pressure. The pressure increases in the direction of the arrow 15.

The rotational speed of the fuel supply pump is plotted on the X-axis 18 and the current uptake of the fuel supply pump is plotted on the Y-axis 19.

The curves 16 and 17 represent limit value curves which are, for example, limits for generating a warning message, which is output when pressures associated with the limits are exceeded.

Given a constant pressure in the fuel supply system, there is a defined current uptake for each rotational speed of the fuel supply pump. Due to the approach to a defined reference point in a targeted manner, as is described in the method according to the invention, a change in the pressure in the fuel supply system is detected and, therefore, the loading of the filter may be inferred.

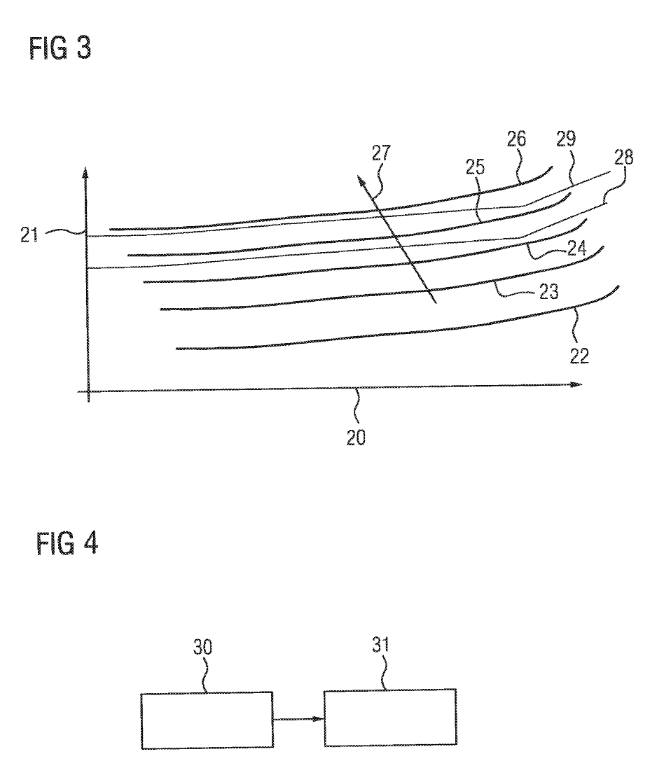

FIG. 3 shows a schematic representation of the pressure prevailing in the fuel supply system with respect to the rotational speed of the fuel supply pump. The rotational speed of the fuel supply pump is plotted on the X-axis 20. The pressure in the fuel supply pump is plotted on the Y-axis 21. The curves 22, 23, 24, 25 and 26 each represent lines having a constant current intensity. The current intensity increases in the direction of the arrow 27 in this case. The curves 28 and 29 represent limit values, and if the limit values are exceeded, for example, a warning message is generated.

FIGS. 2 and 3 also show the close correlation between the rotational speed, the current flowing to the fuel supply pump, and the pressure prevailing in the fuel supply system. Due to the close connection of the three variables to each other, when two of the three variables are known, it is possible to determine the third variable with high accuracy. In addition, due to the great correlation between the pressure prevailing in the fuel supply system and the loading state of the filter, the loading state is determined with high accuracy on the basis of the rotational speed of the fuel supply pump and the current flowing to the fuel supply pump.

FIG. 4 shows a flow chart for the method according to the invention. In block 30, a temporal progression of the rotational speed of the fuel supply pump is detected. In block 31, the detected values are compared, in entirety or in a selected form, with corresponding comparative values that have already been stored, in order to obtain a finding regarding the loading state on the basis of the deviation, such as the time difference.

FIGS. 1 to 4 are used for illustrating the inventive idea and are not limiting in character.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for determining the loading state of a filter situated in a fuel supply system, comprising the steps of:
providing a fuel supply pump;
providing a control unit for controlling the fuel supply pump;
providing a temporal progression of the rotational speed of the fuel supply pump, the temporal progression having at least one value; and
providing at least one comparative value stored in the control unit;
detecting the temporal progression of the rotational speed of the fuel supply pump over a predefined period of time;
comparing the at least one value of the temporal progression of the rotational speed and its associated detection time with the at least one comparative value stored in the control unit.

2. The method of claim 1, further comprising the steps of:
providing at least one predefined rotational speed of the fuel supply pump;
comparing the detection time at which the at least one predefined rotational speed is reached with the at least one comparative value assigned to the predefined rotational speed;
deriving the loading state of the filter from the difference between the detection time and the temporal comparative value.

3. The method of claim 1, further comprising the steps of defining the detection time by a pre-definable current intensity.

4. The method of claim 1, further comprising the steps of detecting the temporal progression of the rotational speed over the predefined period of time, such that the predefined period of time corresponds to a run-up of the fuel supply pump from a standstill.

5. The method of claim 1, further comprising the steps of continuously comparing the detected temporal progression and the stored comparative values.

6. The method of claim 1, further comprising the steps of determining the comparative values based on the temperature of the fuel.

7. The method of claim 1, further comprising the steps of determining the comparative values based on the fuel quality of the fuel.

8. The method of claim 1, further comprising the steps of:
providing a reference point;
calculating the pressure in the fuel delivery system;
operating the fuel supply pump with a constant current intensity at the reference point such that the fuel supply pump reaches a constant rotational speed that is dependent on the pressure in the fuel delivery system.

9. The method of claim 8, further comprising the steps of:
comparing the constant rotational speed of the fuel supply pump with a comparative rotational speed stored in the control unit;
detecting the pressure in the fuel supply system based on the difference between the constant rotational speed of the fuel supply pump and the rotational speed stored in the control unit.

10. The method of one of preceding claims 8, further comprising the steps of:
providing a minimum quantity of fuel; and
providing a maximum quantity of fuel that is presently demanded;
approaching the reference point only when the minimum quantity of fuel required at the reference point is greater than the maximum quantity of fuel that is presently demanded.

11. The method of claim 1, further comprising the steps of:
providing a display system;
storing at least one limit value in the control unit,
outputting a message on the display system if the limit value is exceeded.
